(19) United States
(12) Patent Application Publication
(10) Pub. No.: US 2002/0111142 A1
(43) Pub. Date: Aug. 15, 2002

(54) System, apparatus, and method of estimating multiple-input multiple-output wireless channel with compensation for phase noise and frequency offset

(76) Inventor: Gleb V. Klimovitch, Palo Alto, CA (US)

Correspondence Address: FLEHR HOHBACH TEST, ALBRITTON & HERBERT LLP, Suite 3400, Four Embarcadero Center, San Francisco, CA, 94111, US

(21) Appl. No.: 10/024,120

(22) Filed: Dec. 17, 2001

Related U.S. Application Data
(60) Provisional application No. 60/256,692, filed on Dec. 18, 2000.

(51) Int. Cl. H04B 1/10; H04B 15/00; H04B 17/00

(52) U.S. Cl. 455/63; 455/67.3

(57) ABSTRACT

Method and apparatus for estimating of Multi-Input Multi-Output (MIMO) wireless channels. The estimating (training) sequences are designed, transmitted and processed in such a way that the channel response is estimated for each transmitter, even if transmitters send training sequences at all discrete multitone frequencies simultaneously, and that the negative effects of phase noise and frequency offset on channel estimation are minimized. The proposed sequences are optimal or near-optimal from the viewpoint of mean-squared error in channel estimation for a given energy and duration of the training signal. Within above described scope, several approaches to and designs of channel estimator are proposed.

### RELATED APPLICATIONS

Priority is claimed under 35 U.S.C. §119(e) to U.S. Provisional Application Serial No. 60/256,692 entitled “System, Apparatus, and Method for Multiple-Input Multiple-Output Wireless Communication Channel with Phase Noise and Frequency Offset Compensation” filed Dec. 18, 2000, which is incorporated herein by reference.

### FIELD OF THE INVENTION

This invention pertains generally to wireless communication systems and methods and more particularly to a system and method for communicating using an improved estimate for multiple-input multiple-output wireless channel characteristics having compensation for phase noise and frequency offset.

### BACKGROUND

This invention relates to a method and apparatus for estimation of Multiple-Input Multiple-Output (MIMO) wireless channel characteristics. Training (or estimating) sequences are designed, transmitted and processed in such a way that the channel response is estimated for each transmitter, even if transmitters send training sequences simultaneously. The precision of the channel estimate is improved for channels with short impulse response by means of denoising. The negative effects of phase noise and frequency offset on channel estimation are minimized The proposed training sequences are optimal or near-optimal from the viewpoint of mean-squared error in channel estimation for a given energy and duration of the training signal. Within above-described scope, several approaches to and designs of channel estimator are proposed.

In a system that provides multiple radio-frequency (RF) channels existing within the same physical space, such as for example, a system that has two transmitting RF antennas transmitting to two receiving RF antennas, one would like to estimate the channel parameters for each spatial subchannel, i.e., for each transmitter-receiver pair. One example of a spatial subchannel parameter is the complex transmission coefficient. This subchannel parameter is approximately estimated for each transmitter and receiver pair. In particular, assume we are interested in a series of frequency subchannels, such as would be the case for a multi-carrier technique such as Orthogonal Frequency Division Multiplexing (OFDM). A complex transmission coefficient is estimated for each antenna pair and each frequency.

With respect to FIG. 1 there is illustrated a diagrammatic illustration showing a simplified representation of the estimation of channel characteristics. Training sequences are transmitted sequentially for two antennas (antenna #A1, then antenna #A2). The transmitted training sequences are received by receiving antennas #A1′ and #A2′. Thus, receiving antenna #A1′ and #A2′ first receive the training sequence transmitted from transmitting antenna #A1, then from transmitting antenna #A2. All channel characteristics can then be estimated, utilizing known techniques. See for example chapter 2 in A. R. S. Bahai and B. R. Saltzberg, MultiCarrier Digital Communication, 1999 Kluwer Academic/Plenum Publishers, New York, ISBN 0-306-46296-6; and chapter 5 in R. Van Nee and R. Prasad, OFDM for Wireless Multimedia Communications, Artech House Publishers, Boston and London, ISBN 0-89006-530-6, incorporated herein by reference. Although this scenario provides a potentially operable approach, it has significant disadvantages in that it wastes time, is bandwidth inefficient, and wastes transmit power.

Heretofore it has been known generally that the use of multiple transmit/receive antennas have a substantial benefit on the achievable data rate as compared to single transmit/receive antennas in multipath fading environments. It is also known that the error in channel estimation decreases with the increase in the energy transmitted during training, also referred to as the channel estimation stage. To improve bandwidth efficiency, it is desirable that the duration of training should be minimized.

Unfortunately, the ability to reduce the duration of training is in at least some ways restricted by transmitter peak power limitations imposed by cost and/or technology constraints. Potential coupling of channel outputs may also impose constraints on the extent to which the duration of estimation and training may be reduced.

There therefore remains a need for system and method that overcome these and other limitations.

### SUMMARY

The invention provides a method and apparatus for estimation of multiple-input multiple-output (MIMO) wireless channel characteristics. A method is provided for transmitting training sequence signals by a plurality of transmitting antennas such that the training subsequences are substantially orthogonal when received, through an arbitrary channel, at a plurality of receiving antennas. In one embodiment, the training sequence signals comprise subsequences which are mutually orthogonal at the receiver. The method provides an estimate of channel characteristics by receiving and processing said subsequences. The method thus provides an estimate of the channel characteristics for each transmitting antenna despite interference between transmitting antennas.

One embodiment of the method provides for combining the estimates generated by processing the received subsequences to generate a refined channel estimate including an estimate of frequency offset and phase noise. Errors due to frequency offset and phase fluctuations are thus reduced. In one embodiment, interpolation and/or filtering of the channel estimate in frequency is provided to reduce estimation errors by exploiting redundancy in the frequency-domain representation of a channel with a short impulse response.

The apparatus provides a plurality of transmitting antennas, a plurality of receiving antennas and a receiver configured to generate an estimate of the channel characteristics.

In one embodiment, the receiver is configured to denoise the estimate of the channel characteristics.

A method is provided for denoising an estimate of a wireless channel having a short impulse response. The method comprises estimating a frequency domain channel response, calculating a nontruncated time domain channel response comprising a first set of coefficients by performing a first transform-based procedure on the frequency domain channel response, truncating the nontruncated time-domain channel response by selecting certain of the first set of coefficients to generate a second set of coefficients that define a truncated time-domain channel response and calculating a denoised frequency-domain channel response by performing a second transform based-procedure on the truncated time-domain channel response.

In one embodiment of the denoising method, the first transform-based procedures is an inverse Fourier transform and the second transform-based procedure is a Fourier transform. In another embodiment, the first transform-based procedure is an inverse Fast Fourier transform and the second is a Fast Fourier transform.

### BRIEF DESCRIPTION OF THE DRAWINGS

FIG. 1 is an illustration showing an embodiment of channel estimation with time-domain transmission multiplexing.

FIG. 2 is an illustration showing an embodiment of channel estimation with frequency-domain transmission multiplexing.

FIG. 3 is an illustration showing an embodiment of channel estimation with simultaneous transmission in temporal spatial and frequency-domains for a 2×2 system with 2 training blocks.

FIG. 4 is an illustration showing an embodiment of channel estimation with simultaneous transmission in temporal, spatial and frequency-domains for a 2×2 system with 3 training blocks. The redundancy of training sequency is used to cancel relative frequency offset and phase noise between transmitter and receiver local oscillators.

FIG. 5 is an illustration showing an embodiment of implementation of a communication system using a channel estimator with simultaneous transmission in temporary, spatial and frequency-domains for 2×2 system with 3 training blocks; where the redundancy of training sequence is used to cancel relative frequency offset and phase noise between transmitter and receiver local oscillators.

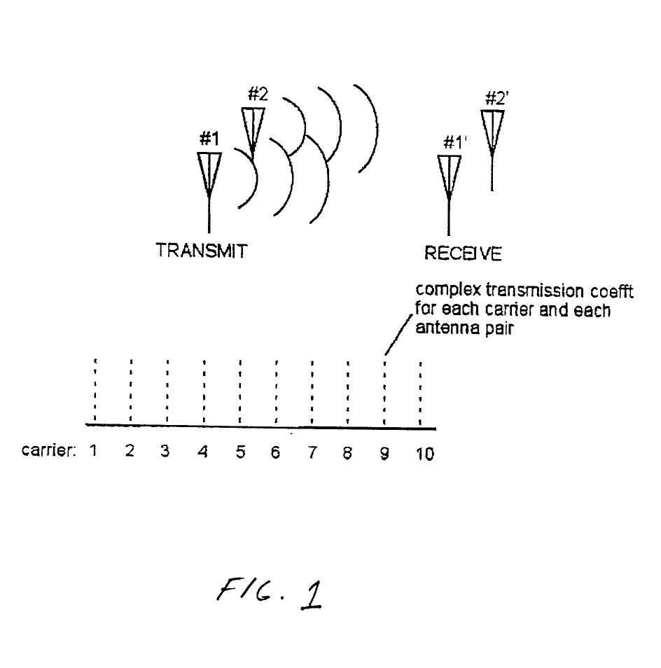

### DETAILED DESCRIPTION

Exemplary embodiments are described with reference to specific configurations. Those skilled in the art will appreciate that various changes and modifications can be made while remaining within the scope of the claims. The discussion below is first directed toward general properties of a communication protocol and the manner in which one embodiment of the invention improves over conventional systems and methods, then toward demonstrating the general properties of optimal training sequences provided by certain embodiments of the invention, then discussing a single-input channel case for the sake of simplifying the discussion. Finally, attention turns toward the multiple-input multiple-output channel.

In one embodiment of the invention, reduction and desirably minimization of channel estimation time (also referred to as training time) are accomplished within a transmitter peak transmit power limitation by sending training sequences simultaneously. Undesirably, such simultaneous transmission introduces the problem of later decoupling (or separating) channel outputs due to the different transmitters at the receiver, so that channel response can be calculated for each transmitter. This decoupling should desirably remain possible for wide and a priori unknown variations in the properties of wireless channels, and embodiments of the invention include several designs of training sequences with operable and in many instances optimal and near-optimal decoupling properties, so that simultaneous transmission of training sequences by different transmitters is no longer problematic.

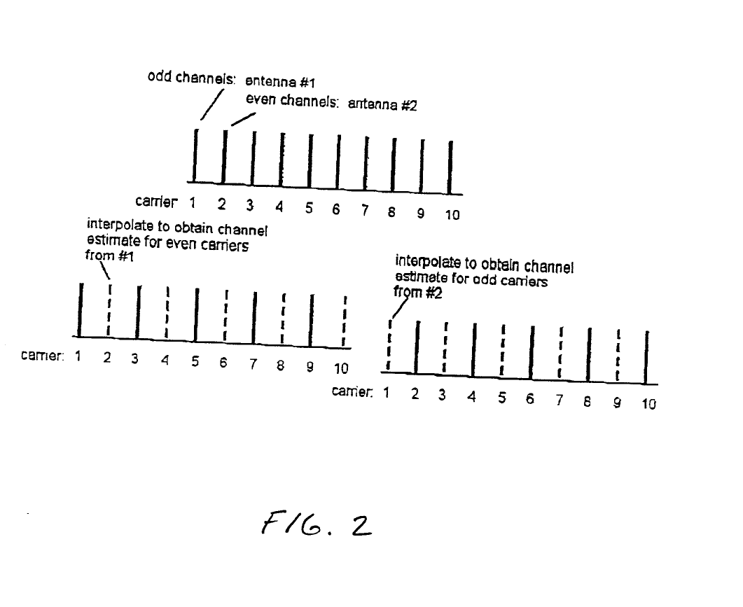

One method to provide such channel estimation involves transmitting the training sequences simultaneously rather than sequentially, and assigning alternate channels to multiple blocks as illustrated in FIG. 2. For example, block “A” (even-numbered) channels to antenna #A1, and block “B” (odd-numbered) channels to antenna #A2. In this case, antenna #A1′ receives training sequences simultaneously from transmitting antennas #A1 and #A2, but the received training sequences can be separated by virtue of the fact they have different carrier frequencies. When channel parameter variation is slow relative to frequency, it is then possible to interpolate in the complex plane to obtain channel estimation for the frequencies not measured. See for example chapter 5 in R. Van Nee and R. Prasad, OFDM for Wireless Multimedia Communications, Artech House Publishers, Boston and London, ISBN 0-89006-530-6, incorporated herein by reference.

An even better approach is to transmit the training sequence twice. In the first case, block A is transmitted by antenna #A1, and block B is transmitted by antenna #A2; while in the second case, block A is transmitted by antenna #A2, and block B is transmitted by antenna #A1. The values of channel coefficients at frequencies which are absent in the training sequence for a given training block are interpolated based on the measured channel coefficients for the same training block, and then the interpolated values are compared with the measured values. Measured values are improved by taking into account interpolated values at the same frequency. In one embodiment, the post processing is or includes taking weighted averages of the measured and interpolated data.

This approach provides a solution in the absence of significant delay spread in the channel but may not provide the desired precision of channel estimation for large delay spread, i.e., long impulse response of the channel. The desired precision may not be provided because of large interpolation errors at large delay spread in the channel, e.g., more than twenty percent of the duration of the training block.

For actual hardware implementations of transmitter and receiver local oscillators the phase offset between transmitter and receiver local oscillators typically depends on time. This dependence manifests itself in zero-mean fluctuations (phase noise) superimposed on the average drift (frequency offset). Unless the typical variations in phase offset during training are small in comparison with the channel noise-to-signal ratio, phase noise and frequency offset deteriorate the quality of channel estimation. In the presence of frequency offsets or phase noise in the systems described above, the perfect orthogonality of the received signals is lost.

An enhancement is therefore described that provide system and method for optimal or near-optimal channel estimation that preserves the orthogonality of received signals affected by frequency offset and/or phase noise. Training sequences, as well as techniques for identifying, constructing, and using these training sequences, are described that compensate for slow phase variations. Slow phase variations are variations in phase that have correlation time larger than eight inverse signal bandwidths. In at least one embodiment, slow phase variation is compensated by building the training sequence out of several successive subsequences, so that the phase offset remains approximately constant during each of the subsequences, and differences in phase offset for different subsequences are estimated and compensated to improve the quality of channel estimation.

The mean-squared error in estimating a wireless channel with short impulse response is reduced by denoising techniques, in comparison with that for a wireless channel with longer impulse response, for the same duration and signal energy of training. A short impulse response wireless channel in this context would generally be an impulse response of duration less than one tenth of the duration of the block of the training sequence. By comparison, a long impulse response in this context would generally be an impulse response of duration more than one third of the duration of the block of the training sequence. This reduction in mean-squared error for a wireless channel with a short impulse response is possible because the number of degrees of freedom in the channel description increases with the length of the channel impulse response, so that shorter channel allows for larger training energy per degree of freedom, and therefore more precise estimate.

It will therefore be appreciated that in one aspect the invention improves over a conventional system and methods by providing a system and method for improving the bandwidth efficiency by reducing the duration of the channel training or estimation stage. In one embodiment, this improvement in bandwidth efficiency is achieved by estimating MIMO channel characteristics by transmitting training sequences simultaneously from a plurality of transmitting antennas.

Attention is now directed toward some characteristics of communication channels over all frequency subchannels and a communication protocol utilizing data blocks, data frames, frame synchronizing sequence, cyclic prefixes, and training blocks; and to some general properties of an embodiment of training sequences in multiple-input multiple-output (MIMO) systems and methods over all frequency subchannels. These training sequences provide improvement over conventional sequences and are optimal or near-optimal.

First, consider a vector wireless additive white Gaussian noise (AWGN) channel with N_{TX} transmitting and N_{RX}≧N_{TX} receiving antennas. Data is sent in blocks preceded by cyclic prefixes. The blocks are organized in frames. Each frame starts with a synchronizing sequence, followed by training blocks, and then data blocks. The channel is quasi-stationary, i.e., it has coherence time longer than eight times the duration of the frame transmission, or in somewhat less technical terms, changes little during transmission of each frame. The relationships between data blocks, data frames, frame synchronizing sequence, cyclic prefixes, and training blocks is illustrated in the figures (See for example FIG. 5.).

If the length of the data block without prefix is L_{block}, we need to know only the response of the channel at L_{block} discrete tones or frequencies. This knowledge is achieved by splitting the training sequence into blocks of the same length as the number of discrete tones L_{block} (plus cyclic prefixes of length L_{prefix}).

Method and procedure for optimizing or at least improving training sequences at both intrablock (micro) and interblock (macro) levels are now described. By intrablock or micro levels is meant within each training block of length L_{block}. By interblock or macro levels is meant by multiplying all the baseband components of a given training block by the same complex number of unit absolute value.

A discussion of general properties of optimal training sequences in MIMO systems follows below. Properties discussed below are advantageously employed by the inventive apparatus and method, as discussed in later sections.

For convenience of description, the remainder of the description is placed into several headings as follows: optimization of the spectrum of the training sequences, orthogonality properties of optimal training sequences in MIMO systems, chirp sequences as building blocks of training sequences, estimation of scalar channel in the presence of phase wander and frequency offset or phase noise denoising, estimation of a MIMO channel disregarding phase wander, estimation of a MIMO channel in the presence of phase wander, and exemplary communication system and architecture. These headings are provided for the convenience of the reader and do not otherwise restrict or limit the subject matter that is disclosed and it will be understood that aspects and elements of the various embodiments are described throughout the description.

Optimization of the spectrum of the training sequences

In this section, a single-input transmission is considered, the extension to multi-input transmission being apparent by extension and by further description hereinafter.

Having accounted for cyclic prefix, we arrive at a periodic channel model in EQ. 1:

Y(w)=X(w)H(w)+N(w), (1)

where w is one of L_{block} equidistant discrete multi-tone (DMT) frequencies, X(w), Y(w), N(w), and H(w) are DMT components of input, output, noise, and channel transfer function, respectively. The estimator produces channel estimate Ĥ(w). We use the mean-squared error (MSE) of the estimate:

$${ϵ}_{ch} = {\sum }_{w} \vert H ( w ) - \hat{H} ( w ) {\vert}^{2} \qquad ( 2 )$$

as its figure of merit. It will be appreciated by those workers having ordinary skill in the art in light of the description provided herein that variations of this figure of merit and alternative figures of merit may be utilized.

In this section, the transfer functions H(w) are assumed for purposes of ease of description to be mutually independent at different frequencies. Such independence may approximately hold for non-line-of-sight communication if the frequency difference is much larger than the delay spread. However, in at least one case of interest, when the block duration is much longer than the delay spread, the nearby frequency components lo of the channel response are strongly correlated, a dependence which is used to mitigate the effects of channel and phase noise as described in additional detail in later sections of this description.

Without a prior knowledge of the channel and for mutually independent H(w), the minimum-mean-squared error (MMSE) channel is unbiased and given by the expression:

$$\hat{H} ( w ) = \frac{Y ( w )}{X ( w )} \qquad ( 3 )$$

with mean-squared-error (MSE) ε_{ch} given by the following expression:

$${ϵ}_{ch} = {N}_{o} {\sum }_{w} \frac{1}{\vert {X ( w )}^{2} \vert} , \qquad ( 4 )$$

where Nₒ is the average noise variance per complex dimension. Given the total signal power in the bloc, ε_{ch} is minimized by using X with flat spectrum ¦X(w)¦²=constant, such as XPRBS or chirp sequence. The second choice (use of a chirp sequence) is probably more convenient because any integer L_{block} is possible of even L_{block}. Note that if the estimating sequence has a non-flat spectrum, the error ε_{ch} is increased by the factor:

E[¦X(w)¦²]E[1/¦X(w)¦_{2b ]>1.} (5)

Orthogonality Properties of Optimal Training Sequences in MIMO Systems

So that the primary features of the inventive system, apparatus, and method are more easily understood, it is instructive to concentrate discussion on a flat channel case initially and then add generalization for the frequency-selective case as provided in later sections of this description. A discrete-time model is used for purposes of description for this flat channel case.

The channel input is described by matrix X whose rows correspond to simultaneous inputs from different transmitters, while each column gives the input sequence in time for the corresponding transmitter. The channel output is described by matrix Y whose rows correspond to simultaneous outputs of different receivers, while each column gives the output sequence in time for the corresponding receiver. The input-output relationship is given by the expression:

Y=XH+N, (6)

where N is noise matrix, and H is the matrix of channel coefficients for each transmitter-receiver pair or N_{TX}×N_{RX} channel matrix. The elements of N are assumed to be Gaussian independently identically distributed (i.i.d.) variables.

Without a priori knowledge of the channel, the MMSE channel estimate is unbiased and given by the expression:

Ĥ=(X^{H}X)^{31 1}X^{H}Y≡pinv(X)Y, (7)

where the matrix pseudo-inverse is defined by the first equality in Eq. (7). The MSE of this channel estimate is:

$${ϵ}_{ch} ≡ Tr [ ( H - \hat{H} ) {( H - \hat{H} )}^{H} ] = {N}_{o} Tr [ {( {X}^{H} X )}^{- 1} ] = {N}_{o} {\sum }_{k = 1}^{{N}_{T X}} \frac{1}{{λ}_{k}} , \qquad ( 8 )$$

where Nₒ is the average noise variance per complex dimension, and {λₖ} are the singular values of matrix X^{H}X sorted in the decreasing order. The notation “Tr[. . . ]” refers to taking the sum of the diagonal elements of the matrix. Note also that X^{H} is the complex conjugate also known as Hermitian adjoint of X and X is advantageously a chirp sequence, as described above.

Given the total signal power in the block Tr[XX^{H}], ε_{ch} is minimized for equal singular values of X^{H}X, for example, when X^{H}X is proportional to the unit matrix. By init matrix, it is meant a square matrix which has unit diagonal elements and zero off-diagonal elements. In other words, the channel inputs from different transmitters (i.e., the columns of X) should be mutually orthogonal and have equal average power during channel estimation, in order to minimize ε_{ch}.

It is straightforward to generalize the foregoing discussion to non-flat channels whose (matrix) transfer functions depend on the frequency of each multitone, as in Eq. (1) are mutually independent at different frequencies, thereby permitting independent estimation of different II(w) (See also the above subsection describing Optimization of the spectrum of the training sequences). The input-output relationship is given by the expression:

Y(w)=X(w)H(w)+N, (9)

where N is noise matrix (assumed for purpose of ready description to be independent of frequency), and H(w) is the N_{TX}×N_{RX} channel matrix. The resulting channel estimate is:

Ĥ(w)=(X^{H}(w)X(w))^{31 1}X(w)^{H}Y≡pinv(X(w))Y, (10)

with MSE

$${ϵ}_{ch} ≡ {\sum }_{w} Tr [ ( H - \hat{H} ( {( H - \hat{H} )}^{H} ] = {N}_{o} {\sum }_{w} Tr [ ( {X ( w )}^{H} {X ( w )}^{- 1} ] {N}_{o} {\sum }_{w} {{\sum }^{{N}_{TX}}}_{k = 1} \frac{1}{{λ}_{k} ( w )} . \qquad ( 11 )$$

Given the total energy of the estimating sequence

$${\sum }_{w} Tr [ {XX}^{H} ] \qquad ( 12 )$$

the error ε_{ch} is minimized, when the SVD values λₖ(w) are the same for different k and w.

λₖ(w)≡const, (13)

that is, for example, when X^{H}X is proportional to the unit matrix. In other words, the frequency components of channel inputs from different transmitters (i.e., the columns of X(w) should be mutually orthogonal and have equal energy. If the training sequences do not satisfy this requirement, the estimation error ε_{ch} increases by the factor:

E[λₖ(w)]E[1/λₖ(w)]>1, (14)

where averaging occurs over both k and w indexes.

For the optimal training sequences and AWGN channel, the estimation error is given by the ratio of the noise energy per degree of freedom Nₒ to the signal energy per degree of freedom Eₒ, that is Eₒ/Nₒ. This simple rule applies no matter if the transmitter has single or multiple antennas, and regardless of whether the channel is flat or frequency-selective.

Some examples of optimal and near-optimal or improved training sequences for single-input channels that apply to MIMO channel estimation are now described.

There are many types of optimal and near-optimal training sequences, for which Eq. (13) λₖ(w)≡const holds or at least approximately holds. However, only a few of such sequences are practical, at least in part because of one or more of transmitter peak power constraints, phase noise, and other restrictions or limitations.

Due to transmitter peak power constraints, it is hardly practical to use sequences with strongly nonuniform time distribution of signal power, such as short pulses, because the power amplifiers needed to output the required peak power are (at present) prohibitively expensive. In particular, the peak power is reduced if all the transmit (TX) antennas transmit simultaneously during the training sequence.

Orthogonality properties of estimating sequences should not be significantly affected by slow changes in phase offset between receive (RX) and transmit (TX) local oscillators. Such changes occur or at least may occur due to carrier frequency offset between the transmitter and receiver local oscillators, as well as by low-frequency phase noise. Compensating for any clock frequency offset and/or clock jitter is not discussed here but are known in the art, see for example chapter 5 in A. R. S. Bahai and B. R. Saltzberg, MultiCarrier Digital Communications, 1999 Kluwer Academic/Plenum Publishers, New York, ISBN 0-306-46296-6, incorporated herein by reference.

If the training sequences are sufficiently long, so that the TX-RX phase offset changes considerably during the training (even after any frequency offset compensation has been applied), then extra techniques should desirably be used to compensate for the remaining fluctuations in phase offset on channel estimation, which affects the design of the training sequences. An example of extra technique is adjusting the phases of different blocks of the training sequence to compensate for variable phase offset between TX and RX local oscillators. For example, a training sequence may advantageously be built of successive training subsequences, each of which subsequence suffices to calculate a channel response, albeit with less precision than the whole training sequence comprised of the plurality of successive subsequences.

By comparing the partial channel estimates due to each subsequence, information about slow phase fluctuations is extracted and used to compensate for the effects of phase noise and frequency offset on channel estimation.

Chirp Sequences as Building Blocks of Training Sequences

Chirp sequences have a form given by the expression:

X_{chirp}[k]∝exp(πjk²/T_{chirp}), (15)

where integer T_{chirp} is the period of the sequence, and index k runs through any T_{chirp} consecutive numbers, for example, k=0, 1, . . . , (T_{chirp} −1). The T_{chirp}-point Fourier transform of the time-domain chirp gives frequency domain chirp, for example, the discrete-frequency power spectral density (PSD) of the chirp is constant. These properties of uniform energy distribution in both time and frequency domain minimize transmitter peak power requirement and estimation error, respectively.

For a single-antenna TX, the whole training sequence may be obtained by concatenating cyclically prefixed chirps. A cyclically prefixed chirp x_{chirp}[k] extended to negative k=-L_{prefix}, -L_{prefix}+1, . . . , −1, where L_{prefix} is the length of the cyclic prefix, such as for example, x_{chirp}[k] for k=−10, −9, . . . , L_{block}. For example, in orthogonal frequency-division multiplexing (OFDM) system with L_{block} discrete multi-tones (DMTs), chirps with period T_{chirps}=L_{block}may be used. The resulting training sequence estimates the channel at all DMT frequencies.

Estimation of Scalar Channel in the Presence of Phase Wander and Frequency Offset or Phase Noise Denoising

To illustrate how one embodiment of the inventive system, apparatus, and method may be used to improve estimation precision in the presence of phase noise, consider the following example. Let the training sequence consist of N_{block} cyclically prefixed chirps. Let Ĥ _{w}(w) stand for a channel estimate derived from the mth block alone. Let the low-frequency phase noise be approximated by blockwise-constant process, that is, a process in which the TX-RX phase offset is constant during each training block.

There are two possible sources of discrepancy between different estimates of channel Ĥ ₘ(W). First, additive channel noise results in random deviations of partial channel estimates from each other. Second, slow phase fluctuations (also referred to as phase wander), which occur on time scales much larger than the block time, result in random rotations of Ĥ ₘ(W):

Ĥ ₘ(w)H ₘ(w)e^{jφm}, (16)

rotations that are the same at different frequencies for a given i.

To obtain an optimal or nearly optimal channel estimate, we combine ĥᵢ(w) as follows. First, we estimate phase differences φₘ−φₙ, where m=1,2, . . . , N_{block} −1 and n −N_{block}, as follows:

$$\begin{matrix}exp [ j ( {φ}_{m} - {φ}_{n} ) ] = \frac{{\sum }_{w} {H}_{m} ( w ) {H}_{n}^{*} ( w )}{{\sum }_{w} {H}_{m} ( w ) {H}_{m}^{*} ( w )} , \\ which reduces to : & ( 17 ) \\ {φ}_{m} - {φ}_{n} = \frac{{\sum }_{w} Im [ {H}_{m} ( w ) {H}_{n}^{*} ( w ) ]}{{\sum }_{w} {H}_{m} ( w ) {H}_{m}^{*} ( w )} , & ( 18 )\end{matrix}$$

for small phase differences, φₘ−φₙ21 21 1.

To compensate for phase wander, partial channel estimates are combined as follows:

$$\hat{H} ( w ) = \frac{{\sum }_{m = 1}^{{N}_{{block}^{- 1}}} {ⅇ}^{j ( - {φ}_{m} + {φ}_{block} )} {H}_{m} ( w ) + {H}_{{N}_{block}} ( w )}{{N}_{block}} , \qquad ( 19 )$$

and the channel is modeled as Ĥ(w) multiplied by a block-constant phase factor.

Estimation of the block-constant phase factor depends on details of the phase noise model. In particular, if phase wander on the time scale of frame length is well approximated by constant frequency offset, the phase factor is obtained by extrapolation of the best linear fit to φₘ−φ_{N block}. The precision of channel estimation may be further improved by decision-aided tuning of phase factor during data transmission.

Estimation of a MIMO Channel

The proposed system, apparatus, and method of efficient estimation of a MIMO channel is closely related with the estimation techniques for a single-input channel discussed above. However, it is desirable to take into account and cancel the interference among different transmitters during the estimation stage.

In one embodiment, this cancellation is achieved by choosing training sequences for different transmitters (channel inputs) to be not only mutually orthogonal but also to produce mutually orthogonal channel outputs, regardless of a particular channel realization. For linear-time-invariant or quasi-time-invariant channels, both input and output orthogonality occurs for training sequences based on either pure frequency division multiplexing or hybrid time-frequency division multiplexing among different transmitters. (Pure time division multiplexing strongly increases requirements on the maximum output power.)

Estimation of a MIMO Channel Disregarding Phase Wander

One of the challenges in estimating a MIMO channel is to obtain separate channel responses for different transmitters, while maintaining simultaneous transmission during training (to satisfy peak power constraints).

To this end, transmitters can be separated in the frequency domain as follows. Given the number of transmitters N_{TX}, choose integer p>N_{TX}, such that 2p divides the number of multi-tones L_{block}. During each training block, each transmitter uses a training sequence x_{p,q}[k] with a different q, and channel response for each is estimated only at the corresponding “on-” frequencies {w_{p,q}}where x_{p,q}[k] is given by:

$${x}_{p , q} [ k ] ∝ exp [ π j p {k}^{2} + \frac{2 qk}{{L}_{block}} ] , \qquad ( 20 )$$

where p and q are integer, and 2p divides L_{block} and w_{p,q} is given by:

$$\{ {w}_{p , q} \} = \frac{2 π}{{L}_{block}} ( np + q ) , \qquad ( 21 )$$

where n is integer.

Channel responses at the rest of the frequencies are obtained either through frequency-domain interpolation, or by using for each transmitter indexes q which depend on the training block, so that for each transmitter q runs through all possible values O, . . . , (p−1).

A related technique to separate channel responses to different transmitters is to properly phase training blocks for different transmitters and block positions, for example, as follows. Let there be N_{block}≧N_{block} training blocks indexed with t=0, . . . , (N_{block}−1). During block t, m-th antenna sends sequence

xₘ[t,k]=exp(2πjmt/N_{block})x_{chirp}[k]. (22)

Let Y[t,k] be the received signal described by vector sequence. Then the channel output due to the chirp transmitted by a single antenna m is given by the m-th component of the Fourier transform of Y[t,k] over the first index (t), from which the channel response for transmitter m is reconstructed by methods for a single-input channel, such as those described in above sections beginning “Estimation of scalar channel in the presence of phase wander and frequency offset or phase noise denoising”.

For example, in one embodiment, the invention provides system, apparatus, and method for transmitting both (or multiple) signals A and B simultaneously (or substantially simultaneously) and providing system, apparatus, and method for extracting individual antenna transmissions from the simultaneously transmitted (and subsequently received) signals. In the case where there are two transmitting antennas, N_{TX}=2, one embodiment of the invention according to the method described above is to transmit two training sequences during two blocks. In this case N_{block}=N_{TX}. In the first training sequence, a signal with equal power spectral density over both channels is transmitted, as determined to be the optimal sequence structure in Eq. (22) for m=0, 1, t=0, 1, and N_{block}=2′.

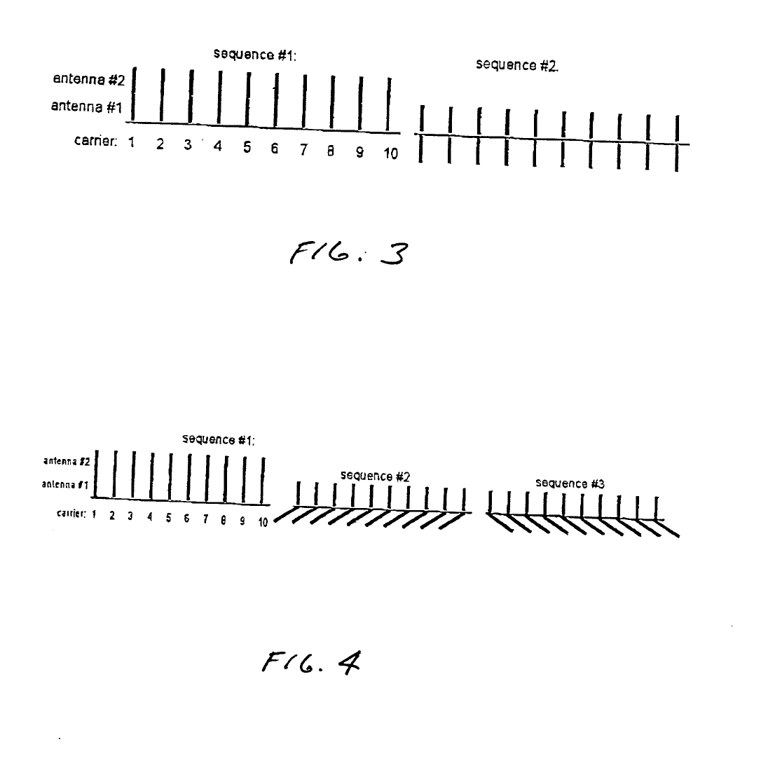

One embodiment of the inventive system, apparatus, and method use a simple “chirp” signal for the first signal that varies in time over the frequency band. In the second training sequence, the phase of the transmission is inverted over the second antenna (antenna #A2), as indicated in Eq. (22) xₘ[t,k] demonstrates this—antenna 2 (m=1) inverts only the second training block (t=1). An embodiment of this technique is illustrated in FIG. 3.

Using this approach, the channel coefficients or parameters corresponding to antennas #A1 and #A2 can then be extracted from the received signals by taking the difference and sum of the consecutive training sequences, respectively. Let the received blocks be given by yₘ[t,k], where n =0,1 stands for the index of the receiving antenna, and t and k are defined above. Then the elements H_{m,n}(ω) of the channel matrix H(ω) is given by:

H_{0,n}(ω)=(Yₙ[0,ω]+Yₙ[1,ω])/2X₀[0,ω]

H_{1,n}(ω)=(Yₙ[0,ω]−Yₙ[1,ω])/2X₀[0,ω]

where Xₘ[t,ω] is the FFT of xₘ[t,k] over the second index in the brackets, and Yₙ[t,ω] is the FFT of yₙ[t,k] over the second index in the brackets. The solution can be generalized to higher numbers of antennas (such as for example 3, 4, 5, 6, or more antennas) by using more general phase factors according to the following equation:

$${H}_{m , n} ( ω ) = {\sum }_{m = 0}^{{N}_{blocks} - 1} \frac{exp ( - 2 π j mt / {N}_{block} )}{{N}_{block} {X}_{0} [ 0 , ω ]}$$

For example, for three antennas and three training blocks, the system and method transmits three sequences, with the phases differing by (2π/3). This would be reflected in Eq. (22) as N_{block}=3 case:

Xₘ[t,k]=exp(2πjmt/3)x_{chirp}[k]

A second embodiment of the invention provide additional enhancements that are more robust in the to the presence of frequency offsets or phase noise, where the afore described inventive and conventional approaches may loose the perfect orthogonality of the received signals in the presence of such frequency offsets or phase noise. This loss of perfect orthogonality is disadvantageous as it results in significant increase in the bit error rate to the extent that operation is sometimes impossible.

Therefore in the second embodiment, the phase noise and/or frequency offset problem is reduced or eliminated by sending additional information to allow extraction of additional phase noise and frequency offset parameters. Referencing Eq. (22), this represents the case where N_{block}>N_{TX}. These additional parameters permit cancellation of phase noise and frequency offset so that given bit error rate is achievable at considerably lower transmitted power.

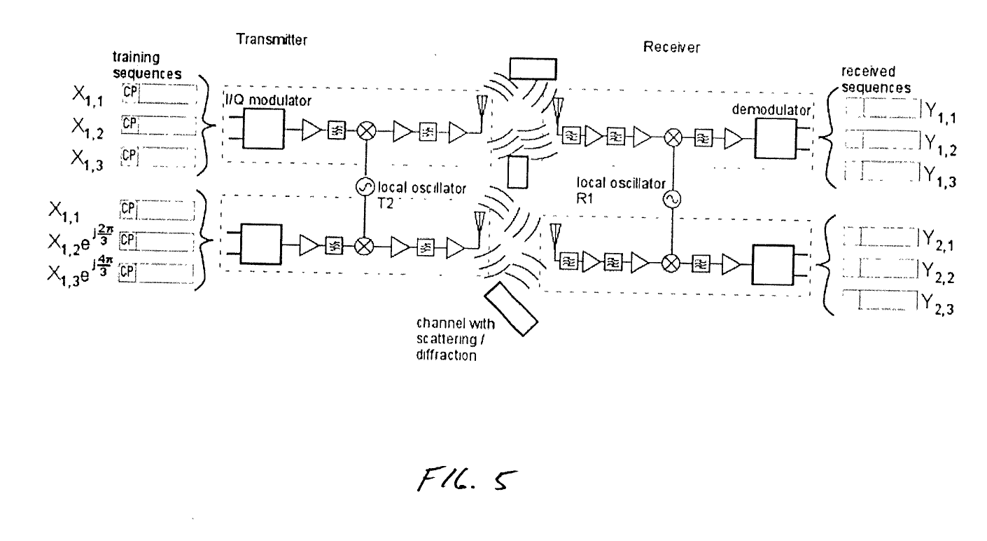

The inventive system, apparatus, and method proceed in the two antenna case as if there were a third antenna: that is, instead of using two transmissions with a relative phase of −1 (inverted phase) on antenna #A2, the approach uses three training sequences in succession with relative phases of (1, a, a²) as illustrated in FIG. 4. In one preferred embodiment, a =exp(27πj/3) though other functions for “a” may alternatively be used so long as Eq. (22) or its equivalent is satisfied. One then proceeds as described above and in even greater detail hereinafter, by extracting a “third antenna channel” as if a third antenna was transmitting. This third antenna channel will be identically 0 (zero) in the absence of additive channel noise, phase noise, and frequency offset. Local oscillator (LO) frequency offset, when present, will show up as an extra signal with magnitude varying linearly with time, a signal which contains “third-channel” components; and both phase noise and additive channel noise will show up as a stochastic “third-channel” signal. Thus from the degrees of freedom present in the received signal that are unused by the transmitter, the inventive system and method permit extraction of information about phase noise and frequency offsets, and correctly estimate the channel.

Estimation of a MIMO Channel in the Presence of Phase Wander

Analogous to the case of a single-input channel, phase wander results in relative phase rotations of channels subestimates obtained during different time periods of estimating stage. To improve precision of channel estimation, such phase rotations should desirably be estimated for and compensated. Moreover, the training sequence itself should desirably be designed so that to have modularity in time, for example, the training sequence estimate should desirably be composed of several subsequences, each of which is located within a certain period of estimating stage and is sufficient to calculate a channel response, although with less precision than the whole or entire training sequence.

Depending on the relationship between the time scale of phase wander rₚₕ, block time T_{block}=L_{block}T_{sym}, training time T_{training}=N_{block}T_{block}, and the number of transmitters N_{TX}, different schemes of phase compensation apply.

For very slow phase wander rₚₕ>>T_{training}no phase compensation is necessary. For somewhat faster phase wander, when

rₚₕ≦T_{training}but rₚₕ>>N_{TX}T_{block},tm (23)

the training subsequences can be identical composed of N_{TX} training blocks each, and given by Eq. (22), where N_{block} is substituted by N_{TX}, and index t stands for the position in the subsequence. The resulting training subsequences are combined according to the techniques described in above sections, including “Estimation of scalar channel in the presence of phase wander and frequency offset or phase noise denoising”, and modified to allow for matrix form of the transfer function. In particular, Eqs. (17) and (18) become

$$\begin{matrix}exp [ j ( {φ}_{m} - {φ}_{n} ) ] = \frac{{\sum }_{w} Tr [ {H}_{m} ( w ) {H}_{n}^{H} ( w ) ]}{{\sum }_{w} Tr [ {H}_{m} ( w ) {H}_{n}^{H} ( w ) ]} , \\ and & ( 24 ) \\ {φ}_{m} - {φ}_{n} = \frac{{\sum }_{w} Im ( Tr [ {H}_{m} ( w ) {H}_{n}^{H} ( w ) ] )}{{\sum }_{w} Tr [ {H}_{m} ( w ) {H}_{n}^{H} ( w ) ]} , & ( 25 )\end{matrix}$$

respectively.

Exemplary Communication System and Architecture

One embodiment of a communication system, and component transmit and receive portions, according to the invention is illustrated in FIG. 5. In the illustrated embodiment, the wireless communication system includes a 2-antenna transmitter (TX). Each of the two transmitter branches of which includes the following elements: an in-phase/quadrature-phase (I/Q) modulator, an intermediate frequency (IF) amplifier, a bandpass filter, a mixer, a radio frequency (RF) preamplifier, a bandpass filter, a power amplifier, and a transmitting antenna. In this particlar embodiment, the mixers in both branches of TX are driven by the same local oscillator with 1/f² spectrum of the phase noise. In one embodiment, the single-sideband (SSB) spectral density of the phase noise is 108 dBc/Hz at 100 KHz frequency offset. This magnitude of phase noise is for example, a typical number for monolithic implementations of a microstrip oscillator. The separation between the TX antennas is assumed for purposes of this example to be two wavelengths at the carrier frequency.

The system also includes a 2-antenna receiver (RX) ), each of the two branches of which includes the following elements (left to right): a receiving antenna, a pre-filter, a low-noise amplifier (LNA), a bandpass filter, a second-stage amplifier, a mixer, a bandpass filter, a third-stage amplifier, and an I/Q demodulator. In this particular embodiment, the mixers in both branches of RX are driven by the same local oscillator with single-sideband (SSB) phase noise of 108 dBc/Hz at 100 KHz frequency offset. Again, for purposes of this example the separation between the antennas is assumed to be two wavelengths at the carrier frequency.

In this embodiment, 1024 discrete multitones (DMT) are used for data transmission. Other numbers of DMT may be used in other embodiments. The non-line-of sight wireless channel described by Rayleigh fading with all the elements of channel matrix independent identically distributed variables with zero mean and unit standard deviation. The length of the channel response in the time domain equal 32 symbol periods, and the length of the cyclic prefix (CP) is 64 symbol periods.

In this exemplary embodiment, channel estimation lasts for three training blocks. For the upper TX branch, each training block is a (cyclically prefixed) chirp sequence. For the lower TX branch, each training block is a (cyclically prefixed) chirp sequence multiplied by the phase factor shown in the lower left portion of FIG. 5.

For this particular embodiment, the average signal-to-noise ratio (SNR) at the receiver is about SNR=32dB. The signal bandwidth is 3MHz, so that the corresponding symbol period in this exemplary embodiment is 0.333 microseconds. The following four situations were simulated as validation of aspects of the inventive system and method each for 10000 channel realizations.

In a first situation, a conventional channel estimator (such as a channel estimator described in Chapter 5 in A. R. S. Bahai and B. R. Saltzberg, MultiCarrier Digital Communications, 1999 Kluwer Academic/Plenum Publishers, New York, ISBN 0-306-46296-6) is assumed where there is a zero frequency offset between the transmit local oscillator (TX LO) and the receiver local oscillator (RX LO). The figure of merit for the channel estimator (in terms of the rot mean square (rms) error of the channel estimation) for this first situation is a relative rms error=0.0557.

In a second situation, a conventional channel estimator (such as a channel estimator described in Chapter 5 in A. R. S. Bahai and B. R. Saltzberg, MultiCarrier Digital Communications, 1999 Kluwer Academic/Plenum Publishers, New York, ISBN 0-306-46296-6, incorporated herein by reference) is assumed where there is a frequency offset between TX LO and RX LO is assumed to have a Gaussian distribution with zero mean and standard deviation of 300 Hz. The figure of merit for the channel estimator (in terms of the rot mean square (rms) error of the channel estimation) for this second situation is a relative rms error=0.106.

In a third situation, an embodiment of the inventive channel estimator described herein is assumed along with a zero frequency offset between TX LO and RX LO. The figure of merit for the channel estimator (in terms of the rot mean square (rms) error of the channel estimation) for this third situation is a relative rms error=0.017.

Finally, in a fourth situation, an embodiment of the inventive channel estimator described herein is assumed along with a frequency offset between TX LO and RX LO having a Gaussian distribution with zero mean and standard deviation of 300 Hz. The figure of merit for the channel estimator (in terms of the rot mean square (rms) error of the channel estimation) for this fourth situation is a relative rms error=0.019.

The comparison of the numbers for the conventional (situations 1 and 2) and inventive (situations 3 and 4) channel estimator show that the inventive system and method provide significantly better precision, especially in the presence of frequency offset (for example situation 2 versus situation 4).

It will be appreciated that the afore described method may be utilized in conjunction with a wireless communication system having a plurality of transmitters and a plurality of receivers. It will also be appreciated that aspects of the inventive methodology may be separately incorporated into one or more transmitter elements and/or one or more receiver elements. Furthermore, the methods described herein may be implemented in hardware, software, firmware, or any combination of these so that the invention may for example include a specialized analog or digital signal processor or processing unit. The invention also provides a computer software program and a computer software program product to the extend that one or more procedures described herein are implemented as computer software instructions for execution in either a general purpose computer or in specialized computer or processing hardware or system.

I claim:

1. A method for multi-input multi-output channel estimation, the method comprising:
transmitting training sequence signals from a plurality of transmitting antennas, through said MIMO channel, such that training sequence signal transmissions from at least two of said plurality of transmitting antennas overlap in time;
receiving said training sequence signals at a plurality of receiving antennas, through said MIMO channel; and
comparing said transmitted training sequence signals with said received training sequence signals to generate an estimate of a characteristic of said MIMO channel.

2. The method of claim 1, wherein said estimate of a MIMO channel characteristic comprises a set of coefficients wherein, for each receiving antenna, at least one coefficient corresponds to each transmitting antenna.

3. The method of claim 1, wherein said transmissions from at least two of the plurality of transmitting antennas occur substantially simultaneously in time.

4. The method of claim 1, wherein said training sequence signals have equal power spectral density in frequency and time.

5. The method of claim 4, wherein said training sequence signals are chirp signals.

6. The method of claim 4, wherein said training sequence signals are sent in blocks and each block is preceded by cyclic prefixes.

7. The method of claim 5, wherein said blocks number as many or more than said transmitting antennas and during one block all transmitted training sequence signals share a same phase.

8. The method of claim 7, wherein during other blocks, all transmitted training sequence signals have a different phase.

9. The method of claim 8, wherein said estimate is generated, at least in part, by a transform based procedure.

10. The method of claim 8, wherein said blocks number N_{block} and said transmitting antennas number N_{TX} where N_{block} is greater than or equal to N_{TX}, and said blocks are numbered according to t where t−>0 . . . , N_{block}−1, and said transmitting antennas are numbered according to m where m−>1 . . . N_{TX}, and said transmitted training sequences, Xₘ[t,k] are proportional to:
xₘ[t,k]=exp(2πjmt/N_{block})exp(πjk²/T_{chirp})
where integer T_{chirp} is the period of the sequence, which equals the length of the training block without the cyclic prefix.

11. The method of claim 1, wherein said training sequence signals comprise a plurality of subsequence signals.

12. The method of claim 11, wherein said subsequence signals comprise an optimal or near-optimal training sequence due to their preserved orthogonality at the receiver.

13. The method of claim 11, wherein said method further comprises:
estimating said channel characteristic for each subsequence;
estimating phase differences between each received subsequence,
combining estimates to estimate the channel response.

14. The method of claim 13, wherein said estimating said channel characteristic for each subsequence comprises estimating said channel characteristics for each subsequence using a transform-based channel characteristic estimation procedure.

15. The method of claim 13, wherein said estimating phase differences between each received subsequence comprises estimating phase differences between each received subsequence using a partial, subsequence-based phase difference estimation procedure.

16. The method of claim 15, wherein said combining estimates to estimate the channel response comprises combining estimates to estimate the channel response using a phase-correcting estimation combining procedure.

17. The method of claim 15, when subsequences are composed of Ntx blocks each and given by Eq. (22) as follows:
Xₘ[t,k]=exp(2πjmt/N_{block})X_{chirp}[k].

18. The method of claim 15, wherein each subsequence is one block long, and a block comprises a cyclically-prefixed chirp sequence.

19. The method of claim 15, wherein said subsequences are shorter than Tblock and given by Eq. (20) as follows:
$${x}_{p , q} [ k ] ∝ exp [ π j \frac{p {k}^{2} + 2 q k}{{L}_{block}} ] .$$

20. The method of claim 15, wherein the method further comprises
denoising the channel estimate by:
calculating a time-domain channel response having a first set of coefficients based, at least in part, on a transform-based procedure performed on the channel estimate;
truncating the time-domain channel response by selecting some of the first set of coefficients and not selecting others of the first set of coefficients;
calculating a denoised channel response by performing a transform-based procedure on the truncated channel response.

21. An apparatus for generating an estimate of a MIMO channel comprising
a plurality of transmit antennas configured to transmit a plurality of training sequences through said MIMO channel;
a plurality of receive antennas configured to receive said plurality of training sequences through said MIMO channel; and
a receiver coupled to said second plurality of antennas configured to generate an estimate of a response of said MIMO channel comprising a coefficient for each transmit antenna-receive antenna pair.

22. The apparatus of claim 21, wherein said receiver is further configured to denoise said estimate.

23. A method for denoising an estimate of a wireless channel having a short impulse response, the method comprising:
estimating a frequency domain channel response;
calculating a nontruncated time domain channel response by performing a first transform-based procedure on said frequency domain channel response and wherein said nontruncated time domain response comprises a first set of coefficients;
truncating said nontruncated time-domain channel response by selecting certain of the first set of coefficients and not selecting others of said first set of coefficients to generate a second set of coefficients that define a truncated time-domain channel response; and
calculating a denoised frequency-domain channel response by performing a second transform-based procedure on said truncated time-domain channel response.

24. The method of claim 23, wherein said first transform-based procedure is an inverse Fourier transform and said second transform-based procedure is a Fourier transform.

25. The method of claim 23, wherein said first transform-based procedure is an inverse Fast Fourier transform and said second transform-based procedure is a Fast Fourier transform.

26. A set of orthogonal signals that, when transmitted and received through a multi-input multi-output channel, remain orthogonal.

27. A method to estimate Multiple-Input Multiple-Output (MIMO) wireless channel with simultaneous or overlapping transmission by different transmitter, and to reduce peak power requirements and/or training time and/or estimation error.

28. An apparatus to estimate Multiple-Input Multiple-Output (MIMO) wireless channel with simultaneous or overlapping transmission by different transmitter, and to reduce peak power requirements and/or training time and/or estimation error.

29. A method to reduce mean-squared estimation error by denoising estimate of a wireless channel with short impulse response.

30. A method to reduce mean-squared estimation error due to phase noise and frequency offset between transmitter and receiver local oscillators and local oscillators. The method is based on training sequences built of successive subsequences, such that their processing at the receiver yields estimate slow changes in the phase offset between transmitter and receiver.

31. A receiver comprising:
I/Q (in-phase/quadrature) modulators, intermediate-frequency (IF) amplifiers, mixers, power amplifiers, bandpass filters, multiple receiving antennas, and a local oscillator.

32. A transmitter comprising:
I/Q (in-phase/quadrature) demodulators, intermediate-frequency (IF) amplifiers, mixers, low-noise amplifiers (LNA), bandpass filters, multiple receiving antennas, and a local oscillator.

33. A transmitter signal control system for generating a plurality of simultaneous training sequences, comprising:
a generator of chirp sequences,
a cyclic prefix adder, and
a phase rotator.

34. A communication system comprising:
a plurality of transmitters;
a plurality of receivers;
a plurality of transmit and receive antennas; and
digital signal processing hardware and/or software for channel estimate, which disentagles the signals arriving from different transmitters by transform-based techniques in both frequency and spatial domains, and compensates for frequency offset and phase noise in the local oscillators at the transmitters and receivers by using the redundancy in the received training signals.
